(19) United States
(12) Patent Application Publication
(10) Pub. No.: US 2026/0166512 A1
(43) Pub. Date: Jun. 18, 2026

(54) DEHYDROGENATION REACTOR AND APPARATUS INCLUDING THE SAME

(71) Applicants: Hyundai Motor Company, Seoul (KR); Kia Corporation, Seoul (KR)

(72) Inventors: Jihui Seo, Hwaseong-Si, (KR); Pyung Soon Kim, Hwaseong-Si (KR); Ji-Hoon Jang, Hwaseong-Si, (KR); Jaeyong Lee, Hwaseong-Si (KR); Hanjin Kim, Hwaseong-Si (KR); Narae Yoon, Hwaseong-Si (KR); Jihye Park, Hwaseong-Si (KR)

(21) Appl. No.: 19/254,378

(22) Filed: Jun. 30, 2025

(30) Foreign Application Priority Data
Dec. 16, 2024 (KR) 10-2024-0186758

(51) Int. Cl. B01J 14/00; B01J 4/00; B01J 19/18

(52) U.S. Cl. CPC B01J 14/00; B01J 4/001; B01J 19/18

(57) ABSTRACT

An apparatus of a reactor may comprise a first housing configured to accommodate one of a chemical hydride or an acid aqueous solution, a second housing configured to accommodate the other of the chemical hydride or the acid aqueous solution, wherein the second housing is different from the first housing, and a coupling assembly configured to selectively and fluidly connect the first housing and the second housing.

### CROSS-REFERENCE TO RELATED APPLICATION

This application claims the benefit of priority to Korean Patent Application No. 10-2024-0186758 filed with the Korean Intellectual Property Office on Dec. 16, 2024, the entire contents of which are incorporated herein by reference.

### FIELD

The present disclosure relates to a dehydrogenation reactor and an apparatus including the same, and more particularly, to a dehydrogenation reactor that is small and has a simplified structure and an apparatus including the same.

### BACKGROUND

The matters described in this Background section are only for enhancement of understanding of the background of the disclosure, and should not be taken as acknowledgment that they correspond to prior art already known to those skilled in the art.

Due to depletion of fossil energy and an environmental pollution problem, there is a high demand for new and renewable alternative energy, and hydrogen is attracting attention as the new and renewable alternative energy.

A fuel cell and a hydrogen combustion device use hydrogen as a reaction gas, and in order to apply the fuel cell and the hydrogen combustion device to a vehicle, various electronic products, or the like, a stable and continuous supply technology for hydrogen is used.

In order to supply hydrogen to a device using hydrogen, a method of receiving hydrogen whenever hydrogen is needed from a separately installed hydrogen supply facility may be used. In this method, compressed hydrogen or liquefied hydrogen may be used for hydrogen storage.

A method in which hydrogen is generated through a chemical reaction by injecting an acid aqueous solution into hydride stored in a reaction vessel may be used to supply hydrogen to the fuel cell or the hydrogen combustion device.

A method for generating hydrogen using hydride may include a method for generating hydrogen by heating metal hydride, a method for generating hydrogen through a catalytic reaction of chemical hydride, or the like.

### SUMMARY

An object of the present disclosure is to provide a dehydrogenation reactor that is small and has a simplified structure and an apparatus including the same.

According to the present disclosure, an apparatus of a reactor, the apparatus may comprise a first housing configured to accommodate one of a chemical hydride or an acid aqueous solution, a second housing configured to accommodate the other of the chemical hydride or the acid aqueous solution, wherein the second housing is different from the first housing, and a coupling assembly configured to selectively and fluidly connect the first housing and the second housing.

The apparatus, wherein the second housing is provided inside the first housing, and wherein the coupling assembly is provided in the second housing. The apparatus, wherein the coupling assembly may comprise an adjustment plate configured to surround an outer surface of the second housing, wherein the adjustment plate has an adjustment communication hole formed corresponding to a housing communication hole formed on an outer side surface of the second housing, and a latch assembly configured to move the adjustment plate.

The apparatus, wherein the latch assembly may comprise a latch protrusion that is formed at the adjustment plate, a latch configured to engage the latch protrusion, and an adjustment valve configured to move the latch. The apparatus may further comprise a first reactant inlet formed in the first housing, into which one of the chemical hydride or the acid aqueous solution is injected, a second reactant inlet formed in the second housing, into which the other of the chemical hydride or the acid aqueous solution is injected, and a hydrogen outlet formed in the first housing, through which hydrogen is discharged.

The apparatus, wherein, the first reactant inlet is disposed at a lower portion of the first housing, the second reactant inlet is disposed at a lower portion of the second housing, and the hydrogen outlet is disposed at an upper portion of the first housing. The apparatus, wherein the coupling assembly may comprise an adjustment plate disposed at a lower portion of the second housing, wherein the adjustment plate has an adjustment communication hole formed to correspond to a housing communication hole formed at the lower portion of the second housing, and a latch assembly configured to move the adjustment plate.

The apparatus, wherein the latch assembly may comprise a latch protrusion that is formed at the adjustment plate, a latch configured to engage the latch protrusion, and an adjustment valve configured to move the latch. The apparatus may further comprise a first reactant inlet formed in the first housing, into which one of the chemical hydride or the acid aqueous solution is injected, a second reactant inlet formed in the second housing, into which the other of the chemical hydride or the acid aqueous solution is injected, and a hydrogen outlet formed in the first housing, through which hydrogen is discharged.

The apparatus, wherein, the first reactant inlet is disposed on a side surface of the first housing, the second reactant inlet is disposed on the side surface of the first housing, and the hydrogen outlet is disposed at an upper portion of the first housing. The apparatus, wherein the coupling assembly may comprise a plurality of adjustment plates respectively provided on two side surfaces of the second housing, wherein each adjustment plate of the plurality of adjustment plates has an adjustment communication hole formed on one of the two side surfaces of the second housing to correspond to a housing communication hole formed on the other of the two side surfaces of the second housing, and a plurality of latch assemblies configured to respectively move the adjustment plates.

The apparatus, wherein each of the plurality of latch assemblies may comprise a latch protrusion that is formed at the corresponding adjustment plate, a latch configured to engage the latch protrusion, and an adjustment valve configured to move the latch. The apparatus may further comprise a first reactant inlet formed in the first housing, into which one of the chemical hydride or the acid aqueous solution is injected, a second reactant inlet formed in the second housing, into which the other of the chemical hydride or the acid aqueous solution is injected, and a hydrogen outlet formed in the first housing, through which hydrogen is discharged.

According to the present disclosure, an apparatus may comprise a first housing configured to receive one of a chemical hydride or an acid aqueous solution, a second housing configured to receive the other of the chemical hydride or the acid aqueous solution, wherein the second housing is disposed adjacent to and physically separated from the first housing, and a coupling assembly configured to selectively and fluidly connect the first housing and the second housing.

The apparatus, wherein the coupling assembly may comprise a partition wall configured to physically separate the first housing from the second housing, wherein a housing communication hole is formed in the partition wall, an adjustment plate having an adjustment communication hole formed to correspond to the housing communication hole, wherein the adjustment plate is configured to be movable at the partition wall, and a latch assembly configured to move the adjustment plate.

The apparatus, wherein the latch assembly may comprise an adjustment boss configured to be fixedly coupled to the adjustment plate, and an adjustment plug configured to be screw-coupled to the adjustment boss. The apparatus, wherein the coupling assembly is implemented as a quick coupler.

The apparatus, wherein the coupling assembly may comprise a partition wall disposed between the first housing and the second housing, an adjustment plate disposed adjacent to the partition wall, and a latch assembly configured to move the adjustment plate, wherein the first housing and the second housing are physically separated by the partition wall and the adjustment plate, and wherein the first housing and the second housing are selectively placed in fluid communication by movement of the adjustment plate via the latch assembly.

According to the present disclosure, an apparatus may comprise a first housing configured to contain a first reactant, a second housing configured to contain a second reactant, a plate positioned between the first housing and the second housing, the plate configured to selectively open a passage between the first housing and the second housing to cause a reaction between the first reactant and the second reactant, and an outlet formed in at least one of the first housing and the second housing and configured to discharge hydrogen generated by the reaction.

The apparatus, wherein the plate is configured to be movable by rotation of a threaded plug coupled to the plate, and the first housing and the second housing are configured to be elongated in a predetermined direction to facilitate heat dissipation without a dedicated cooling component.

In addition, an effect obtained or predicted by an example of the present disclosure is disclosed directly or implicitly in a detailed description of the present disclosure. That is, various effects predicted according to the present disclosure will be disclosed in the detailed description to be described below.

### BRIEF DESCRIPTION OF THE DRAWINGS

The drawings are for reference only in describing examples of the present disclosure, and therefore the technical idea of the present disclosure should not be limited to the accompanying drawings.

FIG. 1 shows an example of a configuration of a dehydrogenation reaction apparatus according to an example.

FIG. 2 shows an example of a configuration of a dehydrogenation reactor according to a first example.

FIG. 3 shows an example of a configuration of a dehydrogenation reactor according to a second example.

FIG. 4 shows an example of a configuration of a dehydrogenation reactor according to a third example.

FIG. 5 shows an example of a configuration of a dehydrogenation reactor according to a fourth example.

FIG. 6 shows an example of a configuration of a dehydrogenation reactor according to a fifth example.

FIG. 7 shows an example of a configuration of a dehydrogenation reactor according to a sixth example.

FIG. 8 shows an example of a configuration of a dehydrogenation reactor according to a seventh example.

FIG. 9 shows an exemplary computing system (e.g., a computing device of a reaction apparatus, a vehicle, or any other apparatus).

The drawings referenced above are not necessarily to scale, but should be understood as providing a somewhat simplified representation of various preferred features that illustrate a basic principle of the present disclosure. For example, specific design features of the present disclosure including a specific dimension, a specific direction, a specific position, and a specific shape will be partially determined by a specific intended application and a specific intended sage environment.

### DETAILED DESCRIPTION

The terminology used herein is for the purpose of describing particular examples only and is not intended to be limiting of the present disclosure. As used herein, the singular forms are intended to include the plural forms as well, unless the context clearly indicates otherwise. It will be further understood that the terms “comprises” and/or “comprising” when used in this specification specify the presence of stated features, integers, steps, operations, elements, and/or components but do not preclude the presence or addition of one or more other features, integers, steps, operations, elements, components, and/or groups thereof. As used herein, the term “and/or” includes any one or all combinations of associated listed items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

With reference to the accompanying drawings, the present disclosure is described in detail so that a person with ordinary skill in the technical field to which the present disclosure belongs may easily practice the present disclosure. However, the present disclosure may be implemented in many different forms and is not limited to the examples described herein.

In order to clearly describe the present disclosure, parts or portions that are irrelevant to the description are omitted, and identical or similar constituent elements throughout the specification are denoted by the same reference numerals.

In the drawings, a size and a thickness of each element are arbitrarily illustrated for ease of description so that the present disclosure is not necessarily limited to what is illustrated in the drawings. In the drawings, the thicknesses of some portions and areas are exaggerated for clarity.

The suffixes “module” and “portion” of an element are used for convenience of description to be interchangeably used and do not have any distinguishable meanings or roles.

In addition, in describing the example disclosed in the present specification, when it is determined that a detailed description of a related known technology may obscure gist of the example disclosed in the present specification, the detailed description thereof will be omitted.

In addition, the accompanying drawings are only intended to facilitate easy understanding of the examples disclosed in this specification, and a technical idea disclosed in this specification is not limited by the accompanying drawings and should be understood to include all modifications, equivalents, or substitutes included in an idea and a technical scope of the present disclosure.

Terms including ordinal numbers such as first and second may be used to describe various elements, but the elements are not limited by the terms.

In the description below, a term described in singular may be interpreted as singular or plural unless an explicit term such as “one” or “single” is used.

Terms are used only for the purpose of distinguishing one element from another element.

Hereinafter, a dehydrogenation reaction apparatus according to an example will be described in detail with reference to the accompanying drawings.

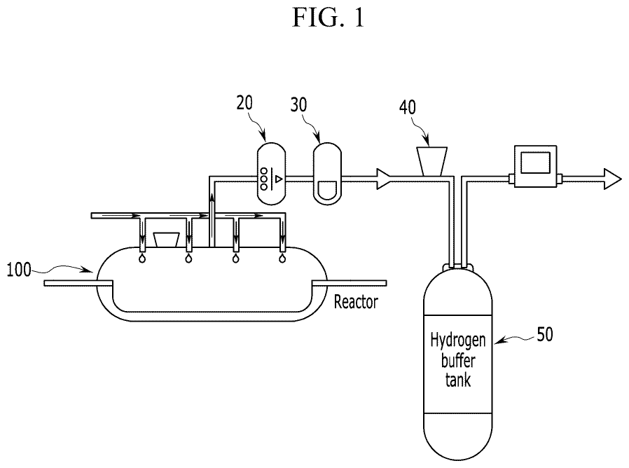

FIG. 1 shows an example of a configuration of the dehydrogenation reaction apparatus according to an example.

As shown in FIG. 1, the dehydrogenation reaction apparatus according to the example may include a dehydrogenation reactor 100 that generates a hydrogen gas through a reaction of chemical hydride with an acid aqueous solution, and a buffer tank 50 that temporarily stores the hydrogen gas generated in the dehydrogenation reactor 100.

The inside of the dehydrogenation reactor 100 may be filled with chemical hydride and an acid aqueous solution. In an example, the chemical hydride and the acid aqueous solution accommodated inside the dehydrogenation reactor 100 may be stored separately, and if necessary, a chemical reaction may occur between the chemical hydride and the acid aqueous solution (e.g., by aligning or opening internal flow paths, rotating valves, or actuating sealing mechanisms, etc.). A structure of the dehydrogenation reactor 100 for implementing such selective mixing will be described later.

The chemical hydride may be in a solid state, and for example, the chemical hydride may be in a form of any one of a powder, a granular material, a bead, a microcapsule, a pellet, or a compacted tablet, etc. Alternatively, the chemical hydride may be in a form of an aqueous solution dissolved in water. If necessary, the chemical hydride may delay the reaction by adding an alkaline material (e.g., NaOH, NaBO₂, KOH, LiOH, CsOH, or RbOH, etc.) to water to increase the pH.

The chemical hydride may be any compound that is hydrolyzed to generate hydrogen and a hydrolyzate, and for example, the chemical hydride may include NaBH₄, LiBH₄, KBH₄, NH₄BH₄, NH₃BH₃, (CH₃)₄NH₄BH₄, NaAlH₄, LiAlH₄, KAlH₄, Ca(BH₄)₂, Mg(BH₄)₂, NaGaH₄, LiGaH₄, KGaH₄, LiH, CaH₂, MgH₂, or a mixture thereof.

The acid aqueous solution may promote a dehydrogenation reaction by adjusting the pH of the chemical hydride to shorten its half-life.

The acid may be an inorganic acid (e.g., sulfuric acid, nitric acid, phosphoric acid, boric acid, or hydrochloric acid, etc.); an organic acid (e.g., heteropolyacid, acetic acid, formic acid, malic acid, citric acid, tartaric acid, ascorbic acid, lactic acid, oxalic acid, succinic acid, or taurine acid, etc.); or a mixture thereof. The formic acid (HCOOH) may be used because it has a small molecular weight compared with a hydrogen ion, thereby helping to reduce a weight of the apparatus, and is safer to handle than the hydrochloric acid in a high concentration state.

The formic acid may be a weak acid, and may be used relatively safely by maintaining the formic acid at a low pH under conditions described in the present disclosure. In addition, it may be an important material in terms of recycling/recirculating carbon dioxide because it may be synthesized from collected carbon dioxide through hydrogenation. Additionally, formate may be converted into bicarbonate through a dehydrogenation reaction, and in this case, additional hydrogen may be obtained.

The buffer tank 50 may temporarily store a hydrogen gas generated in the dehydrogenation reactor 100, and if necessary, the hydrogen gas stored in the buffer tank 50 may be supplied to a hydrogen supply target (e.g., a fuel cell, hydrogen combustion device, portable power generator, or household heating system, etc.). To this end, the dehydrogenation reactor 100 and the buffer tank 50 may be fluidly connected.

A purification device (or a refinement device) 20, a gas-liquid separator 30, and a back pressure regulator 40 may be provided between the buffer tank 50 and the dehydrogenation reactor 100.

The purification device 20 may remove a by-product (e.g., carbon monoxide, ammonia, formaldehyde, or particulate matter, etc.) generated together with hydrogen gasification in the dehydrogenation reactor 100.

To this end, the purification device 20 may be a methanator that removes the carbon monoxide generated in the dehydrogenation reactor 100. The methanator may convert the carbon monoxide generated as the by-product into methane when the hydrogen gas is generated by a dehydrogenation reaction of the hydride and the acid aqueous solution inside the dehydrogenation reactor 100. In the methanator, the hydrogen gas and carbon monoxide gas discharged from the dehydrogenation reactor 100 may pass through a catalyst, so that the carbon monoxide is converted into methane. The catalyst of the methanator may include at least one of nickel (Ni), ruthenium (Ru), cobalt (Co), rhodium (Rh), and iron (Fe). The catalyst may be in a solid state, and for example, the catalyst may be in a form of any one of a granular material, a bead, a microcapsule, a pellet, or porous monolith, etc. Alternatively, the purification device 20 may be a gas filter that removes impurities such as acidic gases or water vapor.

The gas-liquid separator 30 may be provided between the purification device 20 and the buffer tank 50, and may remove moisture and other condensable components (e.g., water vapor, residual acid mist, or entrained liquid droplets, etc.) included in the hydrogen gas generated in the dehydrogenation reactor 100.

The back pressure regulator 40 may be provided upstream of the buffer tank 50, and may increase an internal pressure of the dehydrogenation reactor 100 to a specific pressure (e.g., 10 bar, 20 bar, or higher) for stable extraction of the hydrogen gas from the dehydrogenation reactor 100 and for maintaining sufficient supply pressure to downstream devices (e.g., a fuel cell or hydrogen combustor, etc.).

Hereinafter, a configuration of the dehydrogenation reactor 100 according to a first example will be described in detail with reference to the attached drawings.

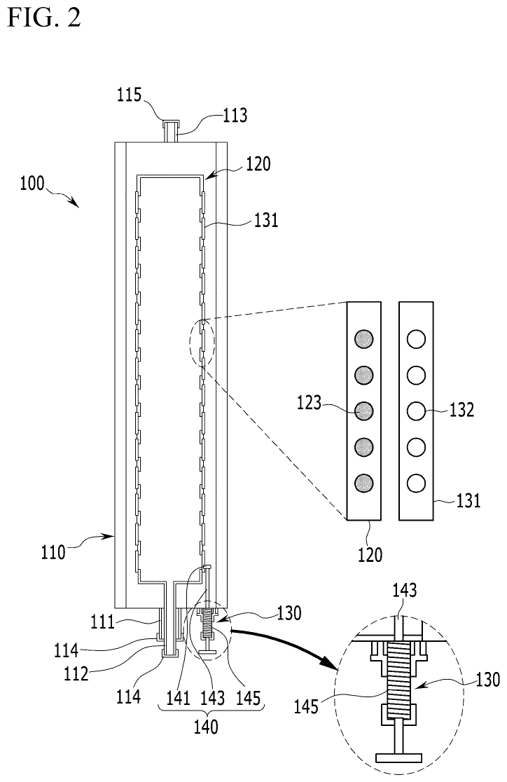

FIG. 2 shows an example of the configuration of the dehydrogenation reactor 100 according to the first example.

As shown in FIG. 2, the dehydrogenation reactor 100 according to the first example may include a first housing 110, a second housing 120 physically separated from the first housing 110, and an adjustment device 130 selectively and fluidly connecting the first housing 110 and the second housing 120.

One of a chemical hydride and an acid aqueous solution may be accommodated in the first housing 110. The first housing 110 may be implemented as a relatively elevated or high-temperature and a relatively elevated or high-pressure container so that the dehydrogenation reaction is performed under a high-temperature and high-pressure condition. For example, the first housing 110 may have a cylindrical shape, a spherical shape, a rectangular parallelepiped shape, or a polygonal column shape, etc., and in particular, the first housing 110 may have the cylindrical shape.

The second housing 120 may be provided inside the first housing 110, and the other of the chemical hydride and the acid aqueous solution may be accommodated in the second housing 120. The second housing 120 may be implemented as a relatively elevated or high-temperature and a relatively elevated or high-pressure container so that the dehydrogenation reaction is performed under a high-temperature and high-pressure condition. For example, the second housing 120 may have a cylindrical shape, a spherical shape, a rectangular parallelepiped shape, or a polygonal column shape, etc., and in particular, the second housing 120 may have the cylindrical shape.

The first housing 110 and the second housing 120 may be formed in a cylindrical shape elongated in a vertical direction. In the first example, a vertical-direction length (hereinafter referred to as a vertical length) and a left-right direction length (hereinafter referred to as a horizontal length) of each of the first housing 110 and the second housing 120 may have a predetermined ratio (e.g., 4:1, 5:1, 6:1, or 7:1, etc.). For example, the vertical length and the horizontal length of each of the first housing 110 and the second housing 120 may have a ratio of 4:1 to a ratio of 7:1. Because the first housing 110 and the second housing 120 are formed long in the vertical direction, heat generated in the dehydrogenation reactor 100 may be easily discharged to the outside, and a separate heat adjustment device 130 (e.g., a heat sink, cooling jacket, or thermal exchanger, etc.) for cooling the dehydrogenation reactor 100 may be removed. Thus, an overall size of the dehydrogenation reaction apparatus may be simplified, and a manufacturing cost thereof may be reduced.

The adjustment device 130 may include an adjustment plate 131 provided to surround the outside of the second housing 120 in order to selectively and fluidly connect the first housing 110 and the second housing 120, and a moving device 140 configured to move the adjustment plate 131.

The adjustment plate 131 may be formed in a cylindrical shape corresponding to an appearance (e.g., the outer surface) of the second housing 120, and an adjustment communication hole 132 corresponding to a housing communication hole 123 formed on an outer side surface of the second housing 120 may be formed in the adjustment plate 131. The adjustment plate 131 may be provided to be movable in a vertical direction on the outer side surface of the second housing 120.

The moving device 140 may move the adjustment plate 131 so that the housing communication hole 123 of the second housing 120 and the adjustment communication hole 132 of the adjustment plate 131 are selectively and fluidly connected. To this end, the moving device 140 may include a latch protrusion 141 formed at the adjustment plate 131, a latch 143 engaged with the latch protrusion 141, and an adjustment valve 145 configured to actuate or move the latch 143.

The latch protrusion 141 may be formed to protrude outwardly in a radial direction of the adjustment plate 131, and the latch 143 may be fixed and caught in the latch protrusion 141. The adjustment valve 145 may be screw-coupled to the latch 143. If necessary, the adjustment valve 145 may be operated by a driving portion, and the driving portion may be implemented as an electric motor, a hydraulic motor, a solenoid, a pneumatic actuator, or another type of mechanical driver, etc.

If necessary, the latch protrusion may be replaced with a latch groove having a groove shape formed in the adjustment plate 131, and the latch 143 may be fixed and caught in the latch groove.

If the adjustment valve 145 is rotated by the driving portion, the latch 143 may move in a vertical direction so that the adjustment plate 131 moves in the vertical direction. If the adjustment plate 131 moves in one direction (e.g., an upward direction), the housing communication hole 123 of the second housing 120 may be blocked (e.g., covered and sealed) by the adjustment plate 131. Accordingly, the chemical hydride (or the acid aqueous solution) accommodated in the first housing 110 and the acid aqueous solution (or the chemical hydride) accommodated in the second housing 120 may not be reacted (e.g., not mix), and a hydrogen gas may not be generated.

If the adjustment plate 131 moves in the other direction (e.g., a downward direction), the housing communication hole 123 of the second housing 120 and the adjustment communication hole 132 of the adjustment plate 131 may communicate with each other. Accordingly, the chemical hydride accommodated in the first housing 110 may flow into the second housing 120, or the acid aqueous solution accommodated in the second housing 120 may flow into the first housing 110. A hydrogen gas may be generated by reacting the chemical hydride with the acid aqueous solution within the first housing 110 and the second housing 120.

In the first example, a rate of hydrogen gas generation (e.g., a speed at which the hydrogen gas is generated) may be adjusted by adjusting an area in which the housing communication hole 123 of the second housing 120 and the adjustment communication hole 132 of the adjustment plate 131 communicate with each other by the moving device 140.

On the other hand, a first reactant inlet 111 configured to inject one of the chemical hydride and the acid aqueous solution into the first housing 110, a second reactant inlet 112 configured to inject the other of the chemical hydride and the acid aqueous solution into the second housing 120, and a hydrogen outlet 113 configured to discharge the hydrogen gas generated inside the first housing 110 and the second housing 120 may be formed in the first housing 110. A discharge valve 115 may be included in the hydrogen outlet 113, and the hydrogen outlet 113 may be selectively opened according to an operation of the discharge valve 115. The discharge valve 115 may be implemented as one of a ball valve, a solenoid valve, a gate valve, a needle valve, and a quick coupler. The discharge valve 115 may be manually opened or closed by an operator, or may be opened or closed by a driving portion (e.g., an electric actuator, pneumatic actuator, or remote control system, etc.).

The first reactant inlet 111 and the second reactant inlet 112 may be formed at a lower portion of the first housing 110, and the hydrogen outlet 113 may be formed at an upper portion of the first housing 110. The first reactant inlet 111 may be provided to surround an outer side of the second reactant inlet 112 in a radial direction. The second reactant inlet 112 may be formed to penetrate the first housing 110 and be fluidly connected to the second housing 120.

The first reactant inlet 111 and the second reactant inlet 112 may be selectively opened. To this end, an injection valve 114 may be included in the first reactant inlet 111 and the second reactant inlet 112. The injection valve 114 may be manually opened or closed by an operator, or may be opened or closed by a driving portion (e.g., an electric actuator, hydraulic actuator, or pneumatic actuator, etc.).

If the first reactant inlet 111 is opened, the chemical hydride (or the acid aqueous solution) may be supplied into the first housing 110. If the second reactant inlet 112 is opened, the acid aqueous solution (or the chemical hydride) may be supplied into the second housing 120.

Hereinafter, the dehydrogenation reactor 100 according to a second example will be described in detail with reference to the attached drawings.

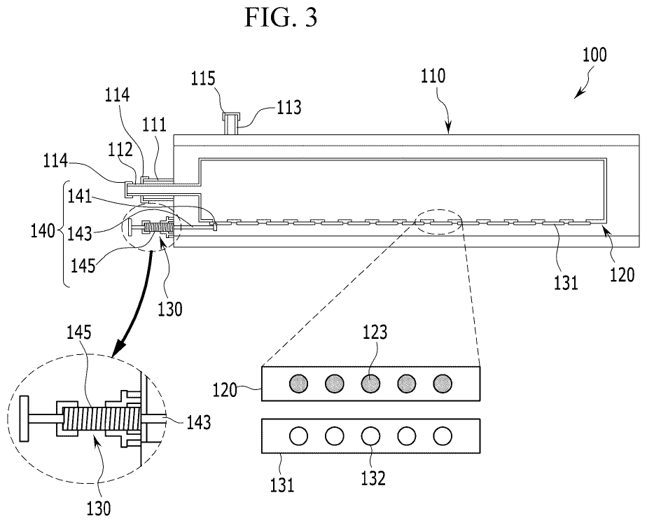

FIG. 3 shows an example of a configuration of the dehydrogenation reactor 100 according to the second example. Because the dehydrogenation reactor 100 according to the second example illustrated in FIG. 3 is generally similar to the dehydrogenation reactor 100 according to the first example illustrated in FIG. 2, only a portion in which the dehydrogenation reactor 100 according to the second example illustrated in FIG. 3 differs from the dehydrogenation reactor 100 according to the first example illustrated in FIG. 2 will be described below.

Referring to FIG. 3, the dehydrogenation reactor 100 according to the second example may include a first housing 110, a second housing 120 physically separated from the first housing 110, and an adjustment device 130 configured to selectively establish fluid communication between the first housing 110 and the second housing 120.

The first housing 110 and the second housing 120 may be formed in a cylindrical shape elongated in a left-right direction. In the second example, a vertical-direction length (hereinafter referred to as a vertical length) and a left-right direction length (hereinafter referred to as a horizontal length) of each of the first housing 110 and the second housing 120 may have a predetermined ratio (e.g., 1:4, 1:5, 1:6, or 1:7, etc.). For example, the vertical length and the horizontal length of each of the first housing 110 and the second housing 120 may have a ratio of 1:4 to a ratio of 1:7. Because the first housing 110 and the second housing 120 are formed long in the left-right direction, heat generated in the dehydrogenation reactor 100 may be easily discharged to the outside, and a separate heat adjustment device 130 (e.g., a cooling pipe, fan unit, or heat sink, etc.) for cooling the dehydrogenation reactor 100 may be removed. Thus, an overall size of the dehydrogenation reaction apparatus may be simplified, and a manufacturing cost thereof may be reduced.

The adjustment device 130 may include an adjustment plate 131 provided at a lower portion of the second housing 120 to selectively and fluidly connect the first housing 110 and the second housing 120, and a moving device 140 configured to move the adjustment plate 131.

The adjustment plate 131 may be formed in an arc shape or a plate shape corresponding to a lower surface of the second housing 120, and an adjustment communication hole 132 corresponding to a housing communication hole 123 formed at a lower portion of the second housing 120 may be formed in the adjustment plate 131. The adjustment plate 131 may be provided to be movable in a left-right direction at the lower portion of the second housing 120.

The moving device 140 may move the adjustment plate 131 so that the housing communication hole 123 of the second housing 120 and the adjustment communication hole 132 of the adjustment plate 131 are selectively and fluidly connected. To this end, the moving device 140 may include a latch protrusion 141 formed at the adjustment plate 131, a latch 143 engaged with the latch protrusion 141, and an adjustment valve 145 configured to actuate or move the latch 143.

Because a configuration of the moving device 140 is the same as that of the first example, a detailed description thereof will be omitted.

If the adjustment valve 145 is rotated by a driving portion, the latch 143 may move in a left-right direction so that the adjustment plate 131 moves in the left-right direction. If the adjustment plate 131 moves in one direction (e.g., a right direction), the housing communication hole 123 of the second housing 120 may be blocked (e.g., covered and sealed) by the adjustment plate 131. Accordingly, the chemical hydride (or the acid aqueous solution) accommodated in the first housing 110 and the acid aqueous solution (or the chemical hydride) accommodated in the second housing 120 may not mix, and hydrogen gas may not be generated.

If the adjustment plate 131 moves in the other direction (e.g., a left direction), the housing communication hole 123 of the second housing 120 and the adjustment communication hole 132 of the adjustment plate 131 may communicate with each other. Accordingly, the chemical hydride accommodated in the first housing 110 may flow into the second housing 120, or the acid aqueous solution accommodated in the second housing 120 may flow into the first housing 110. A hydrogen gas may be generated by reacting the chemical hydride with the acid aqueous solution within the first housing 110 and the second housing 120.

In the second example, a speed or a rate at which the hydrogen gas is generated may be adjusted by adjusting an area (e.g., an overlap area) in which the housing communication hole 123 of the second housing 120 and the adjustment communication hole 132 of the adjustment plate 131 communicate with each other by the moving device 140.

On the other hand, similarly to the first example, the dehydrogenation reactor 100 according to the second example may include a first reactant inlet 111, a second reactant inlet 112, and a hydrogen outlet 113. As in the first example, an injection valve 114 may be included in the first reactant inlet 111 and the second reactant inlet 112, and a discharge valve 115 may be included in the hydrogen outlet 113.

The first reactant inlet 111 and the second reactant inlet 112 may be formed on a side surface of the first housing 110, and the hydrogen outlet 113 may be formed on an upper portion of the first housing 110. The first reactant inlet 111 may be provided to surround an outer side of the second reactant inlet 112 in a radial direction (e.g., concentrically arranged with a shared axis or mounting port, etc.).

Hereinafter, the dehydrogenation reactor 100 according to a third example will be described in detail with reference to the attached drawings.

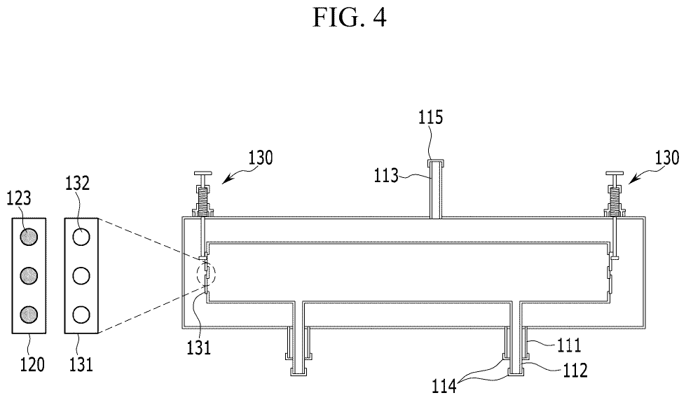

FIG. 4 shows an example of a configuration of the dehydrogenation reactor 100 according to the third example. Because the dehydrogenation reactor 100 according to the third example illustrated in FIG. 4 is generally similar to the dehydrogenation reactor 100 according to the first example illustrated in FIG. 2, only the portion in which the dehydrogenation reactor 100 according to the third example illustrated in FIG. 4 differs from the dehydrogenation reactor 100 according to the first example illustrated in FIG. 2 will be described below.

Referring to FIG. 4, the dehydrogenation reactor 100 according to the third example may include a first housing 110, a second housing 120 physically separated from the first housing 110, and an adjustment device 130 configured to selectively establish fluid communication between the first housing 110 and the second housing 120.

The first housing 110 and the second housing 120 may be formed in a cylindrical shape elongated in a left-right direction. In the third example, a vertical-direction length (hereinafter referred to as a vertical length) and a left-right direction length (hereinafter referred to as a horizontal length) of each of the first housing 110 and the second housing 120 may have a predetermined ratio (e.g., 1:4, 1:5, 1:6, or 1:7, etc.). For example, the vertical length and the horizontal length of each of the first housing 110 and the second housing 120 may have a ratio of 1:4 to a ratio of 1:7. Because the first housing 110 and the second housing 120 are formed long in the left-right direction, heat generated in the dehydrogenation reactor 100 may be easily discharged to the outside, and a separate heat adjustment device 130 (e.g., a fan, radiator, or coolant system, etc.) for cooling the dehydrogenation reactor 100 may be removed. Thus, an overall size of the dehydrogenation reaction apparatus may be simplified, and a manufacturing cost thereof may be reduced.

The adjustment device 130 may include an adjustment plate 131 provided on a side surface of the second housing 120 to selectively and fluidly connect the first housing 110 and the second housing 120, and a moving device 140 configured to move the adjustment plate 131. In the third example, the adjustment plate 131 may be provided on both side surfaces of the second housing 120.

The adjustment plate 131 may be formed in a plate shape corresponding to a side surface of the second housing 120, and an adjustment communication hole 132 corresponding to a housing communication hole 123 formed at a lower portion of the second housing 120 may be formed in the adjustment plate 131. The adjustment plate 131 may be provided to be movable in a vertical direction along the side surface of the second housing 120 to selectively align or block the housing communication hole 123.

The moving device 140 may move the adjustment plate 131 so that the housing communication hole 123 of the second housing 120 and the adjustment communication hole 132 of the adjustment plate 131 are selectively and fluidly connected. To this end, the moving device 140 may include a latch protrusion 141 formed at the adjustment plate 131, a latch 143 engaged with (e.g., caught on) the latch protrusion 141, and an adjustment valve 145 configured to actuate (e.g., move) the latch 143.

Because a configuration and an operation of the moving device 140 are the same as those of the first example, a detailed description thereof will be omitted.

In the third example, the rate of hydrogen gas generation (e.g., a speed at which the hydrogen gas is generated) may be adjusted by adjusting an area in which the housing communication hole 123 of the second housing 120 and the adjustment communication hole 132 of the adjustment plate 131 communicate with each other by the moving device 140.

On the other hand, as in the first example, the dehydrogenation reactor 100 according to the third example may include a first reactant inlet 111, a second reactant inlet 112, and a hydrogen outlet 113. As in the first example, an injection valve 114 may be included in the first reactant inlet 111 and the second reactant inlet 112, and a discharge valve 115 may be included in the hydrogen outlet 113.

The first reactant inlet 111 and the second reactant inlet 112 may be formed at a lower portion of the first housing 110, and the hydrogen outlet 113 may be formed at an upper portion of the first housing 110. The first reactant inlet 111 may be provided to surround an outer side of the second reactant inlet 112 in a radial direction (e.g., concentrically arranged to enable compact multi-fluid injection, etc.). In the third example, because the first housing 110 and the second housing 120 are formed long in the left-right direction, a plurality of first reactant inlets 111 and a plurality of second reactant inlets 112 (e.g., two first reactant inlets 111 and two second reactant inlets 112, or more, depending on flow requirements, etc.) may be formed at a lower portion of the first housing 110.

Hereinafter, the dehydrogenation reactor 100 according to a fourth example will be described in detail with reference to the attached drawings.

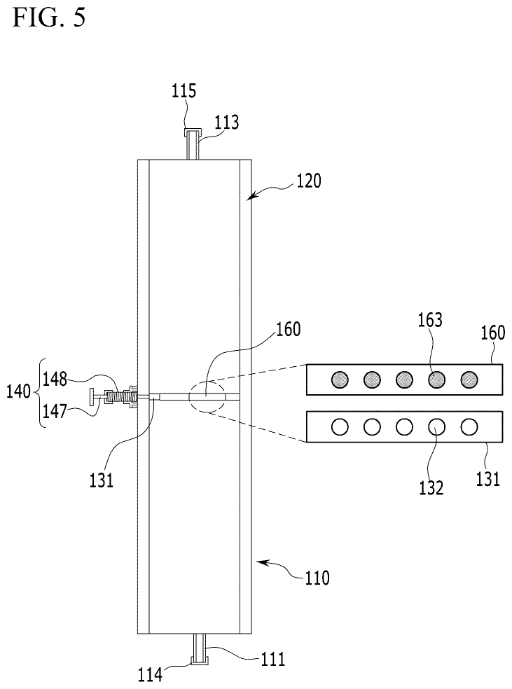

FIG. 5 shows an example of a configuration of the dehydrogenation reactor 100 according to the fourth example. Because the dehydrogenation reactor 100 according to the fourth example illustrated in FIG. 5 is generally similar to the dehydrogenation reactor 100 according to the first example illustrated in FIG. 2, only a portion in which the dehydrogenation reactor 100 according to the fourth example illustrated in FIG. 5 differs from the dehydrogenation reactor 100 according to the first example illustrated in FIG. 2 will be described below.

Referring to FIG. 5, the dehydrogenation reactor 100 according to the fourth example may include a first housing 110, a second housing 120 disposed adjacent to and physically separated from the first housing 110, and an adjustment device 130 configured to selectively establish fluid communication between the first housing 110 and the second housing 120.

One of chemical hydride and an acid aqueous solution may be accommodated in the first housing 110. The first housing 110 may be implemented as a high-temperature and high-pressure container so that the dehydrogenation reaction is performed under a high-temperature and high-pressure condition (e.g., above 80° C. and 1.5 atm, etc.). For example, the first housing 110 may have a cylindrical shape, a spherical shape, a rectangular parallelepiped shape, or a polygonal column shape, and in particular, the first housing 110 may have the cylindrical shape (e.g., to facilitate uniform pressure distribution and ease of manufacturing, etc.).

The second housing 120 may be disposed adjacent to the first housing 110, and the other of the chemical hydride and the acid aqueous solution may be accommodated in the second housing 120 (e.g., if the first housing contains the chemical hydride, the second housing contains the acid aqueous solution, and vice versa, etc.). The second housing 120 may be implemented as a high-temperature and high-pressure container so that the dehydrogenation reaction is performed under a high-temperature and high-pressure condition (e.g., similar to or matching the conditions maintained in the first housing 110, such as above 80° C. and 1.5 atm, etc.). For example, the second housing 120 may have a cylindrical shape, a spherical shape, a rectangular parallelepiped shape, or a polygonal column shape, and in particular, the second housing 120 may have the cylindrical shape (e.g., to ensure structural consistency with the first housing 110 and facilitate compact integration, etc.).

A partition wall 160 may be provided between the first housing 110 and the second housing 120, and the first housing 110 and the second housing 120 may be physically separated by the partition wall 160. A partition wall communication hole 163 may be formed in the partition wall 160 (e.g., to allow selective mixing of the chemical hydride and acid aqueous solution through a controllable interface, etc.).

The first housing 110 and the second housing 120 may be formed in a cylindrical shape elongated in a vertical direction. In the fourth example, a vertical-direction length (hereinafter referred to as a vertical length) and a left-right direction length (hereinafter referred to as a horizontal length) of each of the first housing 110 and the second housing 120 may have a predetermined ratio (e.g., 4:1, 5:1, 6:1, or 7:1, etc.). For example, the vertical length and the horizontal length of each of the first housing 110 and the second housing 120 may have a ratio of 4:1 to a ratio of 7:1 (e.g., enabling efficient space utilization and promoting natural convection, etc.). Because the first housing 110 and the second housing 120 are formed long in the vertical direction, heat generated in the dehydrogenation reactor 100 may be efficiently discharged to the outside, and a separate heat adjustment device 130 for cooling the dehydrogenation reactor 100 may be removed (e.g., a cooling fan, a heat sink, or a thermal jacket, etc.). Thus, an overall size of the dehydrogenation reaction apparatus may be reduced, and a manufacturing cost thereof may be lowered.

The adjustment device 130 may include the partition wall 160 provided between the first housing 110 and the second housing 120 to selectively and fluidly connect the first housing 110 and the second housing 120, an adjustment plate 131 movably provided on the partition wall 160 (e.g., slidably, pivotably, or rotatably mounted, etc.), and a moving device 140 configured to move the adjustment plate 131.

The adjustment plate 131 may be formed in a plate shape corresponding to the partition wall 160, and an adjustment communication hole 132 corresponding to the partition wall communication hole 163 formed in the partition wall 160 may be formed at the adjustment plate 131 (e.g., to align and create a controlled passage for mixing, etc.). The adjustment plate 131 may be provided to be movable in a left-right direction at the partition wall 160.

The moving device 140 may include an adjustment boss 147 fixedly coupled to the adjustment plate 131, and an adjustment plug 148 screw-coupled to the adjustment boss 147.

The adjustment boss 147 may be formed by extending from the adjustment plate 131 and the adjustment plug 148 may be screw-coupled to the adjustment boss 147, so that the adjustment plate 131 moves in the left-right direction by rotation of the adjustment plug 148 (e.g., by manually turning or by an automated driver such as a stepper motor, etc.). If necessary, the adjustment plug 148 may be operated by a driving portion.

If an adjustment valve 145 is rotated by a driving portion, a latch 143 may move in a left-right direction so that the adjustment plate 131 moves in the left-right direction. If the adjustment plate 131 moves in one direction (e.g., toward a right direction), the partition wall communication hole 163 of the partition wall 160 may be covered and blocked by the adjustment plate 131 (e.g., to prevent premature mixing of reactants such as NaBH₄ and formic acid, or NH₃BH₃ and acetic acid, etc.). Accordingly, the chemical hydride (or the acid aqueous solution) accommodated in the first housing 110 and the acid aqueous solution (or the chemical hydride) accommodated in the second housing 120 may remain separated without reacting, and thus, a hydrogen gas may not be generated (e.g., to enable storage before intentional activation of a hydrogen-producing reaction, etc.).

If the adjustment plate 131 moves in the other direction (e.g., toward a left direction), the partition wall communication hole 163 of the partition wall 160 and the adjustment communication hole 132 of the adjustment plate 131 may become aligned and communicate with each other. Accordingly, the chemical hydride accommodated in the first housing 110 may inflow into the second housing 120, or the acid aqueous solution accommodated in the second housing 120 may inflow into the first housing 110. A hydrogen gas may be generated by reacting the chemical hydride with the acid aqueous solution within the first housing 110 and the second housing 120 (e.g., through NaBH₄ and formic acid, NH₃BH₃ and hydrochloric acid, or LiAlH₄ and citric acid, etc.).

In the fourth example, a speed at which the hydrogen gas is generated may be adjusted by adjusting an area in which the partition wall communication hole 163 of the partition wall 160 and the adjustment communication hole 132 of the adjustment plate 131 communicate with each other by the moving device 140 (e.g., varying the overlap area between the holes to modulate reaction rate, etc.).

If desired, the partition wall communication hole 163 and the adjustment communication hole 132 may not be formed in the partition wall 160 and the adjustment plate 131. In this case, the partition wall 160 and the adjustment plate 131 may be configured to overlap or come into close contact, with each other, and the first housing 110 and the second housing 120 may be physically separated by the partition wall 160 and the adjustment plate 131. The adjustment plate 131 may be moved by the moving device 140 so that the first housing 110 and the second housing 120 are selectively communicated.

If the adjustment plate 131 is moved in a right direction by the moving device 140, the partition wall 160 and the adjustment plate 131 may overlap or may be in close contact with each other (e.g., creating a physical seal that prevents fluid flow and mixing, etc.). If the partition wall 160 and the adjustment plate 131 overlap or are in close contact with each other, the first housing 110 and the second housing 120 may be physically separated so that a first reactant and a second reactant do not react (e.g., not mix) with each other and a hydrogen gas is not generated.

If the adjustment plate 131 is moved in a left direction by the moving device 140, a gap (or a clearance) may be generated between the partition wall 160 and the adjustment plate 131, and the first reactant and the second reactant (e.g., NaBH₄ and HCOOH, or LiAlH₄ and H₂SO₄, etc.) may be mixed through the gap to generate the hydrogen gas. In this case, a speed at which the hydrogen gas is generated may be adjusted by adjusting a size (e.g., width or area) of the gap between the partition wall 160 and the adjustment plate 131.

On the other hand, the dehydrogenation reactor according to the fourth example may include a first reactant inlet 111 and a hydrogen outlet 113. Similarly, to the first example, an injection valve 114 (e.g., a solenoid valve, a needle valve, or a ball valve, etc.) may be included in the first reactant inlet 111, and a discharge valve 115 (e.g., a quick coupler or a check valve, etc.) may be included in the hydrogen outlet 113.

The first reactant inlet 111 may be provided at a lower portion of the first housing 110, and the hydrogen outlet 113 may be provided at an upper portion of the second housing 120. If necessary, the hydrogen outlet 113 may also function as a reactant inlet for injecting a reactant (e.g., in cases where reverse flow is required for system priming or maintenance purposes).

Hereinafter, the dehydrogenation reactor 100 according to a fifth example will be described in detail with reference to the attached drawings.

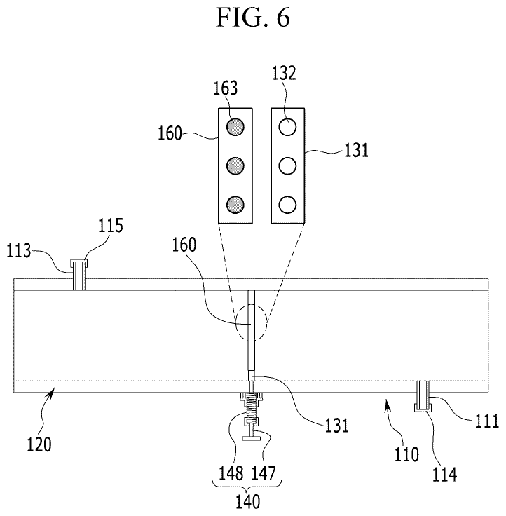

FIG. 6 shows an example of a configuration of the dehydrogenation reactor 100 according to a fifth example. Because the dehydrogenation reactor 100 according to the fifth example illustrated in FIG. 6 is generally similar to the dehydrogenation reactor 100 according to the fourth example illustrated in FIG. 5, only a portion in which the dehydrogenation reactor 100 according to the fifth example illustrated in FIG. 6 differs from the dehydrogenation reactor 100 according to the fourth example illustrated in FIG. 5 will be described below.

Referring to FIG. 6, the dehydrogenation reactor 100 according to the fifth example may include a first housing 110, a second housing 120 disposed adjacent to and physically separated from the first housing 110, and an adjustment device 130 selectively and fluidly connecting the first housing 110 and the second housing 120 (e.g., via a valve, a plate mechanism, or a sliding structure, etc.).

A partition wall 160 may be provided between the first housing 110 and the second housing 120, and the first housing 110 and the second housing 120 may be physically separated by the partition wall 160. A partition wall communication hole 163 may be formed at the partition wall 160 (e.g., a circular, elliptical, or rectangular opening, etc.).

The first housing 110 and the second housing 120 may be formed in a cylindrical shape elongated in a left-right direction. In the fifth example, a vertical-direction length (hereinafter referred to as a vertical length) and a left-right direction length (hereinafter referred to as a horizontal length) of each of the first housing 110 and the second housing 120 may have a predetermined ratio (e.g., from 1:4 to 1:7, etc.). For example, the vertical length and the horizontal length of each of the first housing 110 and the second housing 120 may have a ratio of 1:4 to a ratio of 1:7 (e.g., 1:4, 1:5.5, or 1:7, etc.). Because the first housing 110 and the second housing 120 are formed to be long in the left-right direction, heat generated in the dehydrogenation reactor 100 may be easily discharged to the outside, and a separate heat adjustment device 130 for cooling the dehydrogenation reactor 100 may be removed. Thus, the overall size of the dehydrogenation reaction apparatus may be simplified, and a manufacturing cost thereof may be reduced.

A configuration and an operation of a moving device 140 may be generally similar to those of the fourth example. However, in the fifth example, the adjustment plate 131 may be provided to be movable in a vertical direction with respect to the partition wall 160 (e.g., by sliding, rotating, or lifting, etc.).

Additionally, a first reactant inlet 111 may be formed at a lower portion of the first housing 110, and a hydrogen outlet 113 may be formed at an upper portion of the second housing 120 (e.g., opposite sides to facilitate vertical flow, etc.). Similarly, to the first example, an injection valve 114 may be included in the first reactant inlet 111, and a discharge valve 115 may be included in the hydrogen outlet 113 (e.g., a solenoid valve, a ball valve, or a quick coupler, etc.).

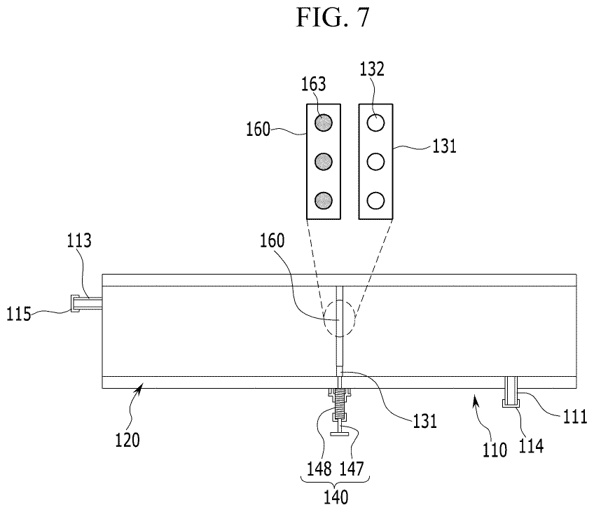

If necessary, the hydrogen outlet 113 may be formed on a side surface of the second housing 120 (e.g., a lateral cylindrical wall, an end cap, or a peripheral flange, etc.) (see a sixth example of FIG. 7). If necessary, a filter for filtering a reactant (e.g., residual liquid or unreacted reactant) may be included in the hydrogen outlet 113.

If the hydrogen outlet 113 is formed on a side surface of the second housing 120, both a hydrogen gas and traces of a reactant may be simultaneously discharged through the hydrogen outlet 113. The filter may be formed with a very small pore size (e.g., a pore size of 1 micrometer, 0.5 micrometer, or even 0.1 micrometer, etc.). Because the reactant is filtered by the filter, the reactant may be prevented from being discharged through the hydrogen outlet 113 (e.g., ensuring gas-phase purity for downstream systems, etc.).

Hereinafter, the dehydrogenation reactor 100 according to a seventh example will be described in detail with reference to the attached drawings.

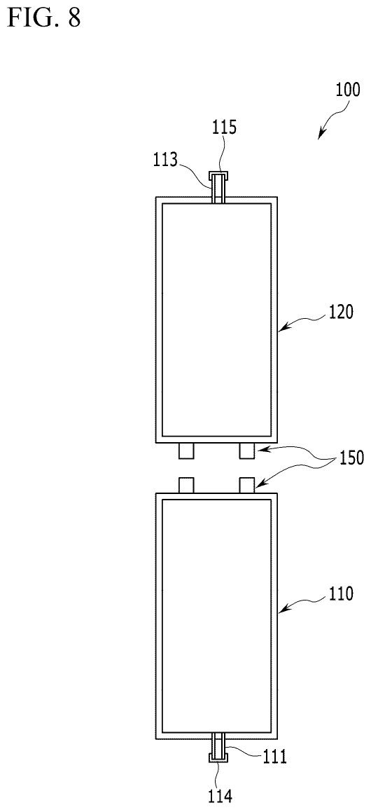

FIG. 8 shows an example of a configuration of the dehydrogenation reactor 100 according to a seventh example. Because the dehydrogenation reactor 100 according to the seventh example illustrated in FIG. 8 is generally similar to the dehydrogenation reactor 100 according to the fourth example illustrated in FIG. 5, only a portion in which the example configuration and structure differ from the dehydrogenation reactor 100 according to the fourth example illustrated in FIG. 5 will be described below.

Referring to FIG. 8, the dehydrogenation reactor 100 according to the seventh example may include a first housing 110, a second housing 120 disposed adjacent to and physically separated from the first housing 110, and an adjustment device 130 configured to selectively establish and interrupt fluid communication between the first housing 110 and the second housing 120.

The first housing 110 may be provided at an upper portion of the second housing 120, and the adjustment device 130 may be provided between the first housing 110 and the second housing 120.

The adjustment device 130 may be a quick coupler 150 provided between the first housing 110 and the second housing 120 to selectively and fluidly connect the first housing 110 and the second housing 120. The quick coupler 150 may be actuated by a driving portion.

If the quick coupler 150 is disengaged (e.g., released or separated) by the driving portion, the first housing 110 and the second housing 120 may be physically separated, the chemical hydride (or the acid aqueous solution) accommodated in the first housing 110 and the acid aqueous solution (or the chemical hydride) accommodated in the second housing 120 may not react, and a hydrogen gas may not be generated.

If the quick coupler 150 is engaged (e.g., coupled) by the driving portion, the chemical hydride accommodated in the first housing 110 may flow into the second housing 120, or the acid aqueous solution accommodated in the second housing 120 may flow into the first housing 110. A hydrogen gas may be generated by reacting the chemical hydride with the acid aqueous solution within the first housing 110 and the second housing 120.

According to the dehydrogenation reactor 100 according to the example and a dehydrogenation reaction apparatus including the same, a first reactant (e.g., a chemical hydride such as sodium borohydride, lithium aluminum hydride, or calcium hydride, etc.) and a second reactant (e.g., an acid aqueous solution such as hydrochloric acid solution, sulfuric acid solution, or acetic acid solution, etc.) may be separated and stored in the first housing 110 and the second housing 120 of the dehydrogenation reactor 100, and the first housing 110 and the second housing 120 may be selectively and fluidically connected through the adjustment device 130. Accordingly, a configuration such as a separate pump (e.g., a peristaltic pump, diaphragm pump, or piston pump, etc.) and/or a separate reservoir tank (e.g., a chemical supply tank or liquid feed tank, etc.) for supplying the acid aqueous solution into the dehydrogenation reactor 100 may be removed. Thus, a compact size of the dehydrogenation reaction apparatus may be achieved, and a manufacturing cost thereof may be reduced.

In addition, because horizontal and vertical lengths of each of the first housing 110 and the second housing 120 of the dehydrogenation reactor 100 are formed long in a predetermined direction with a predetermined ratio (e.g., a ratio of 1:4, 1:5, or 1:7, etc.), heat generated in the dehydrogenation reactor 100 may be easily discharged to the outside. Thus, a heat adjustment device 130 (e.g., a radiator, heat sink, or coolant loop, etc.) may be removed, an overall size of the dehydrogenation reaction apparatus may be reduced, and a manufacturing cost thereof may be reduced.

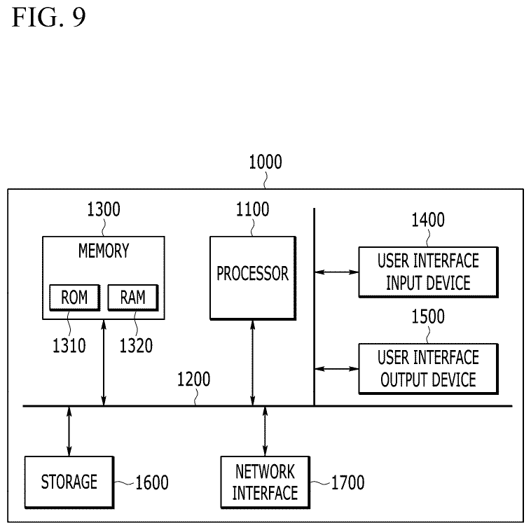

FIG. 9 shows an exemplary computing system (e.g., a computing device of a reaction apparatus, a vehicle, or any other apparatus). One or more controllers, processors, etc. described herein, such as one or more components of a reaction apparatus, one or more components of a vehicle, or any other components and devices disclosed herein, may be implemented by or in the exemplary computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A dehydrogenation reactor according to an example of the present disclosure includes: a first housing in which one of chemical hydride and an acid aqueous solution is accommodated; a second housing in which the other of the chemical hydride and the acid aqueous solution is accommodated and physically separated from the first housing; and an adjustment device that selectively and fluidly connects the first housing and the second housing.

In some examples, the second housing may be provided inside the first housing, and the adjustment device may be provided in the second housing.

In some examples, the adjustment device may include: an adjustment plate that is provided to surround the outside of the second housing and has an adjustment communication hole formed corresponding to a housing communication hole formed on an outer side surface of the second housing; and a moving device that moves the adjustment plate.

In some examples, the moving device may include: a latch protrusion that is formed at the adjustment plate; a latch that catches the latch protrusion; and an adjustment valve that moves the latch.

In some examples, the dehydrogenation reactor may further include: a first reactant inlet formed in the first housing and into which one of chemical hydride and an acid aqueous solution is injected; a second reactant inlet formed in the second housing and into which the other of the chemical hydride and the acid aqueous solution is injected; and a hydrogen outlet formed in the first housing and through which hydrogen is discharged.

In some examples, the first reactant inlet may be provided at a lower portion of the first housing, the second reactant inlet may be provided at a lower portion of the second housing, and the hydrogen outlet may be provided at an upper portion of the first housing.

In some examples, the adjustment device may include: an adjustment plate that is provided at a lower portion of the second housing and has an adjustment communication hole formed corresponding to a housing communication hole formed at the lower portion of the second housing; and a moving device that moves the adjustment plate.

In some examples, the moving device may include: a latch protrusion that is formed at the adjustment plate; a latch that catches the latch protrusion; and an adjustment valve that moves the latch.

In some examples, the dehydrogenation reactor may further include: a first reactant inlet formed in the first housing and into which one of chemical hydride and an acid aqueous solution is injected; a second reactant inlet formed in the second housing and into which the other of the chemical hydride and the acid aqueous solution is injected; and a hydrogen outlet formed in the first housing and through which hydrogen is discharged.

In some examples, the first reactant inlet may be provided on a side surface of the first housing, the second reactant inlet may be provided on a side surface of the first housing, and the hydrogen outlet may be provided at an upper portion of the first housing.

In some examples, the adjustment device may include: adjustment plates each provided on both sides of the second housing and having adjustment communication holes formed corresponding to housing communication holes each formed on both side surfaces of the second housing; and a plurality of moving devices that respectively move the adjustment plates.

In some examples, each of the moving devices may include: a latch protrusion that is formed at the adjustment plate; a latch that catches the latch protrusion; and an adjustment valve that moves the latch.

In some examples, the dehydrogenation reactor may further include: a first reactant inlet formed in the first housing and into which one of chemical hydride and an acid aqueous solution is injected; a second reactant inlet formed in the second housing and into which the other of the chemical hydride and the acid aqueous solution is injected; and a hydrogen outlet formed in the first housing and through which hydrogen is discharged.

A dehydrogenation reactor according to another example includes: a first housing in which one of chemical hydride and an acid aqueous solution is accommodated; a second housing in which the other of the chemical hydride and the acid aqueous solution is accommodated, disposed adjacent to the first housing, and physically separated from the first housing; and an adjustment device that selectively and fluidly connects the first housing and the second housing.

In some examples, the adjustment device may include: a partition wall physically separating the first housing and the second housing and in which a housing communication hole is formed; an adjustment plate in which an adjustment communication hole corresponding to the housing communication hole is formed and is provided to be movable at the partition wall; and a moving device that moves the adjustment plate.

In some examples, the moving device may include: an adjustment boss that is fixedly coupled to the adjustment plate; and an adjustment plug that is screw-coupled to the adjustment boss.

In some examples, the adjustment device may be implemented as a quick coupler.

In some examples, the adjustment device may include a partition wall that is provided between the first housing and the second housing, an adjustment plate that is disposed adjacent to the partition wall, and a moving device that moves the adjustment plate, the first housing and the second housing may be physically separated by the partition wall and the adjustment plate, and the first housing and the second housing may be selectively communicated by the moving device.

A dehydrogenation reaction apparatus according to an example includes the dehydrogenation reactor.

According to the examples, a first reactant and a second reactant may be separated and stored inside a first housing and a second housing of a dehydrogenation reactor, and the first housing and the second housing may be selectively and fluidly connected through an adjustment device. Thus, separate components for supplying an acid aqueous solution may be removed, an overall size of a dehydrogenation reaction apparatus may be reduced, and a manufacturing cost thereof may be reduced.

While this disclosure has been described in connection with what is presently considered to be practical examples, it should be understood that the disclosure is not limited to the disclosed examples, but, on the contrary, is intended to cover various modifications and equivalent arrangements included within the spirit and scope of the appended claims.

What is claimed is:

1. An apparatus of a reactor, the apparatus comprising:
a first housing configured to accommodate one of a chemical hydride or an acid aqueous solution;
a second housing configured to accommodate the other of the chemical hydride or the acid aqueous solution, wherein the second housing is different from the first housing; and
a coupling assembly configured to selectively and fluidly connect the first housing and the second housing.

2. The apparatus of claim 1, wherein the second housing is provided inside the first housing, and wherein the coupling assembly is provided in the second housing.

3. The apparatus of claim 2, wherein the coupling assembly comprises:
an adjustment plate configured to surround an outer surface of the second housing, wherein the adjustment plate has an adjustment communication hole formed corresponding to a housing communication hole formed on an outer side surface of the second housing; and
a latch assembly configured to move the adjustment plate.

4. The apparatus of claim 3, wherein the latch assembly comprises:
a latch protrusion that is formed at the adjustment plate;
a latch configured to engage the latch protrusion; and
an adjustment valve configured to move the latch.

5. The apparatus of claim 3, further comprising:
a first reactant inlet formed in the first housing, into which one of the chemical hydride or the acid aqueous solution is injected;
a second reactant inlet formed in the second housing, into which the other of the chemical hydride or the acid aqueous solution is injected; and
a hydrogen outlet formed in the first housing, through which hydrogen is discharged.

6. The apparatus of claim 5, wherein:
the first reactant inlet is disposed at a lower portion of the first housing,
the second reactant inlet is disposed at a lower portion of the second housing, and
the hydrogen outlet is disposed at an upper portion of the first housing.

7. The apparatus of claim 2, wherein the coupling assembly comprises:
an adjustment plate disposed at a lower portion of the second housing, wherein the adjustment plate has an adjustment communication hole formed to correspond to a housing communication hole formed at the lower portion of the second housing; and
a latch assembly configured to move the adjustment plate.

8. The apparatus of claim 7, wherein the latch assembly comprises:
a latch protrusion that is formed at the adjustment plate;
a latch configured to engage the latch protrusion; and
an adjustment valve configured to move the latch.

9. The apparatus of claim 7, further comprising:
a first reactant inlet formed in the first housing, into which one of the chemical hydride or the acid aqueous solution is injected;
a second reactant inlet formed in the second housing, into which the other of the chemical hydride or the acid aqueous solution is injected; and
a hydrogen outlet formed in the first housing, through which hydrogen is discharged.

10. The apparatus of claim 9, wherein:
the first reactant inlet is disposed on a side surface of the first housing,
the second reactant inlet is disposed on the side surface of the first housing, and
the hydrogen outlet is disposed at an upper portion of the first housing.

11. The apparatus of claim 1, wherein the coupling assembly comprises:
a plurality of adjustment plates respectively provided on two side surfaces of the second housing, wherein each adjustment plate of the plurality of adjustment plates has an adjustment communication hole formed on one of the two side surfaces of the second housing to correspond to a housing communication hole formed on the other of the two side surfaces of the second housing; and
a plurality of latch assemblies configured to respectively move the adjustment plates.

12. The apparatus of claim 11, wherein each of the plurality of latch assemblies comprises:
a latch protrusion that is formed at the corresponding adjustment plate;
a latch configured to engage the latch protrusion; and
an adjustment valve configured to move the latch.

13. The apparatus of claim 11, further comprising:
a first reactant inlet formed in the first housing, into which one of the chemical hydride or the acid aqueous solution is injected;
a second reactant inlet formed in the second housing, into which the other of the chemical hydride or the acid aqueous solution is injected; and
a hydrogen outlet formed in the first housing, through which hydrogen is discharged.

14. An apparatus comprising:
a first housing configured to receive one of a chemical hydride or an acid aqueous solution;
a second housing configured to receive the other of the chemical hydride or the acid aqueous solution, wherein the second housing is disposed adjacent to and physically separated from the first housing; and
a coupling assembly configured to selectively and fluidly connect the first housing and the second housing.

15. The apparatus of claim 14, wherein the coupling assembly comprises:
a partition wall configured to physically separate the first housing from the second housing, wherein a housing communication hole is formed in the partition wall;
an adjustment plate having an adjustment communication hole formed to correspond to the housing communication hole, wherein the adjustment plate is configured to be movable at the partition wall; and
a latch assembly configured to move the adjustment plate.

16. The apparatus of claim 15, wherein the latch assembly comprises:
an adjustment boss configured to be fixedly coupled to the adjustment plate; and
an adjustment plug configured to be screw-coupled to the adjustment boss.

17. The apparatus of claim 14, wherein the coupling assembly is implemented as a quick coupler.

18. The apparatus of claim 14, wherein the coupling assembly comprises:
a partition wall disposed between the first housing and the second housing,
an adjustment plate disposed adjacent to the partition wall, and
a latch assembly configured to move the adjustment plate,
wherein the first housing and the second housing are physically separated by the partition wall and the adjustment plate, and
wherein the first housing and the second housing are selectively placed in fluid communication by movement of the adjustment plate via the latch assembly.

19. An apparatus comprising:
a first housing configured to contain a first reactant;
a second housing configured to contain a second reactant;
a plate positioned between the first housing and the second housing, the plate configured to selectively open a passage between the first housing and the second housing to cause a reaction between the first reactant and the second reactant; and
an outlet formed in at least one of the first housing and the second housing and configured to discharge hydrogen generated by the reaction.

20. The apparatus of claim 19, wherein:
the plate is configured to be movable by rotation of a threaded plug coupled to the plate, and
the first housing and the second housing are configured to be elongated in a predetermined direction to facilitate heat dissipation without a dedicated cooling component.
